(19) United States
(12) Patent Application Publication
(10) Pub. No.: US 2004/0185196 A1
(43) Pub. Date: Sep. 23, 2004

(54) Packaged potable liquid with UV absorber for reduced off-taste from closure and method

(76) Inventors: Yu Shi, Alpharetta, GA (US); Hsiao Hua Liu, Atlanta, GA (US); Mark Rule, Atlanta, GA (US)

Correspondence Address: SUTHERLAND ASBILL & BRENNAN LLP, 999 PEACHTREE STREET, N.E., ATLANTA, GA, 30309, US

(21) Appl. No.: 10/393,857

(22) Filed: Mar. 21, 2003

(51) Int. Cl. F16L 1/00

(52) U.S. Cl. 428/34.1

(57) ABSTRACT

A packaged potable liquid, such as bottled water, wherein the liquid has little or no plastic off-taste, and method for packaging a potable liquid. The packaged potable liquid includes a container, a potable ozonated liquid within the container, and a removable closure having a sealing portion for contacting the container and sealing the opening. The sealing portion of the closure comprises an organic slip agent capable of dissolving in the potable ozonated liquid and undergoing photo-oxidation on exposure to ultraviolet light to form an off-taste imparting compound, and the container comprises an ultraviolet light absorber for protecting the organic slip agent from exposure to ultraviolet light.

### TECHNICAL FIELD

This invention relates to packaged potable liquid such as bottled water, and, particularly, relates to a potable liquid packaging which does not impart an off-taste to the potable liquid.

### BACKGROUND OF THE INVENTION

Water packaged in plastic containers is a large segment of the beverage market. Historically, water packaged in plastic containers develops an off-taste after a short period of storage. This off-taste is often described as a “plastic” off-taste and is most pronounced in water packaged in polyolefin containers, but is also noted in containers made of other plastics, such as PET, especially if the container is closed with a polyolefin closure.

It is known to those skilled in the art that the plastic off-taste can be correlated with the presence of long-chain aldehydes, particularly the aldehydes such as octanal, nonanal, trans-2-decenal, and undecenal. These aldehydes are detectable by taste in water at the parts per billion (ppb) level. Although the plastic off-taste is noticeable in all waters packaged in plastic containers, it is particularly noticeable if the water has been treated with ozone prior to packaging.

The origin of the plastic off-taste is commonly thought to arise from thermal degradation of the polyolefins during processing; consequently, antioxidants are frequently added to the polyolefins to inhibit these degradation reactions. This approach achieves some reduction in the amount of plastic off-taste developed during storage of water in these containers; however, a plastic off-taste is frequently still noticeable.

Prior art inventions to address this problem, such as PCT patent application WO 96/04833, involve the addition of agents that can complex with aldehydes. Unfortunately, because of the low concentration of these aldehydes and their significant solubility in water, this approach only removes a small portion of the aldehydes.

According to U.S. Pat. No. 6,465,066, it has been discovered that the formation of aldehydes during thermal processing of polyolefins, and particularly on exposure to ozonated water, is not due to the thermal degradation of the polyolefins themselves, but rather is due to the degradation of the ethylenically unsaturated slip agents and lubricants used. These lubricants are typically unsaturated fatty acid amides. As lubricants, the fatty acid amides are used to improve mold flow and mold release for polyolefins. Slip agents improve the torque removal properties of the closure. In other words, slip agents make it easier to remove a closure which has been tightly threaded onto a container.

A particularly popular lubricant is erucamide. Erucamide is also used almost universally as a slip agent in polyolefin closures. In this role, the erucamide functions to reduce the coefficient of friction between the closure liner (or closure shell) and the container finish. Without such a slip agent, removal torques for such closures would be unacceptably high. Erucamide is widely used as a slip agent and lubricant because of its low cost and useful properties. Erucamide is a C-22 fatty acid amide that possesses a double bond at the C-13 position. Ozone, in particular, is extremely effective at selectively cleaving this double bond, creating the C-9 aldehyde nonanal.

In addition to exposure to ozone and thermal degradation, there is another potential source of long-chain aldehydes derived from erucamide. Organic slip agents not only convert to off-taste compounds when exposed to ozone or peroxides, but also upon exposure to ultraviolet light. Sources of ultraviolet light are not only sunlight, but also fluorescent and incandescent lighting. Thus, almost all packaging is exposed to sources of ultraviolet light during its manufacture, distribution, and use.

One approach to reduce off-taste from slip agents is to use ethylenically saturated slip agents in polyolefin closure shells, closure liners, and containers to avoid the formation of aldehydes such as nonanal. While such an approach is acceptable, there remains a need for plastic packaging that includes ethylenically unsaturated slip agents, but does not impart a plastic off-taste to potable liquids such as water.

### SUMMARY OF THE INVENTION

This invention addresses the above described problem in the prior art by providing a packaged potable liquid comprising a container, a potable ozonated liquid within the container, and a removable closure having a sealing portion for contacting the container and sealing a container opening, wherein the sealing portion of the closure includes an organic slip agent and the container including an ultraviolet light absorber for protecting the organic slip agent from exposure to ultraviolet light. The sealing portion of the closure includes a first plastic matrix and the organic slip agent is dispersed in the first plastic matrix. Inherently, because the slip agent must be present on the surface of the plastic to be effective, the slip agent is capable of dissolving in the potable ozonated liquid and subsequently undergoing photo-oxidation on exposure to ultraviolet light to form off-taste imparting compounds. The container includes the ultraviolet light absorber which protects the organic slip agent from exposure to ultraviolet light and reduces further oxidation of the slip agent to the off-taste imparting compounds. In a preferred embodiment, the potable ozonated liquid is ozonated water and the organic slip agent is an unsaturated fatty acid amide such as erucamide.

This invention also encompasses a method for packaging potable liquid in a container comprising UV absorber as described above. The method comprises filling a container with a potable ozonated liquid through an opening in the container and sealing the container opening with a removable closure having a sealing portion contacting the container.

It is known that organic slip agents not only convert to off-taste compounds when exposed to ozone or peroxides, but also upon exposure to ultraviolet light. However, while it has been recognized that ethylenically unsaturated slip agents can undergo photodegradation to form undesirable aldehydes, prior art attempts to address this issue have focused only on adding UV absorbers to the closures that contain the ethylenically unsaturated slip agent. These prior art attempts to address off-taste from exposure of closures to UV light did not contemplate that these ethylenically unsaturated slip agent can dissolve into the contained liquid, and can subsequently undergo photooxidation from UV light that penetrates the package sidewall. In fact, UV protection for packages containing water and ozonated water is counter-intuitive to those skilled in the art, since water is considered to be inert to UV degradation reactions. Thus, it is unobvious that it is not enough to protect the closure from ultraviolet light, but that it is also necessary to protect the dissolved slip agent in the potable liquid from exposure to UV light. This deficiency is remedied by the present invention, wherein ultraviolet light absorbers in the container sidewall provides such protection.

### BRIEF DESCRIPTION OF DRAWINGS

FIG. 1 is a perspective view of packaged potable water made in accordance with an embodiment of this invention.

FIG. 2 is a sectional elevation view of a closure for the packaged liquid illustrated in FIG. 1.

FIG. 3 is a plan view of the closure illustrated in FIG. 2.

FIG. 4 is a perspective view of the closure liner in the closure illustrated in FIG. 2.

FIG. 5 is a graph illustrating the level of octanal over time in packaged water made in accordance with an embodiment of this system.

FIG. 6 is a graph illustrating the level of nonanal over time in packaged water made in accordance with an embodiment of this system.

FIG. 7 is a graph illustrating the level of decenal over time in packaged water made in accordance with an embodiment of this system.

FIG. 8 is a graph illustrating the level of decenal over time in packaged water made in accordance with another embodiment of this system.

### DETAILED DESCRIPTION OF EMBODIMENTS

As summarized above, this invention encompasses packaged potable liquid with reduced plastic off-taste in the potable liquid. Below is a detailed description of embodiments of this invention.

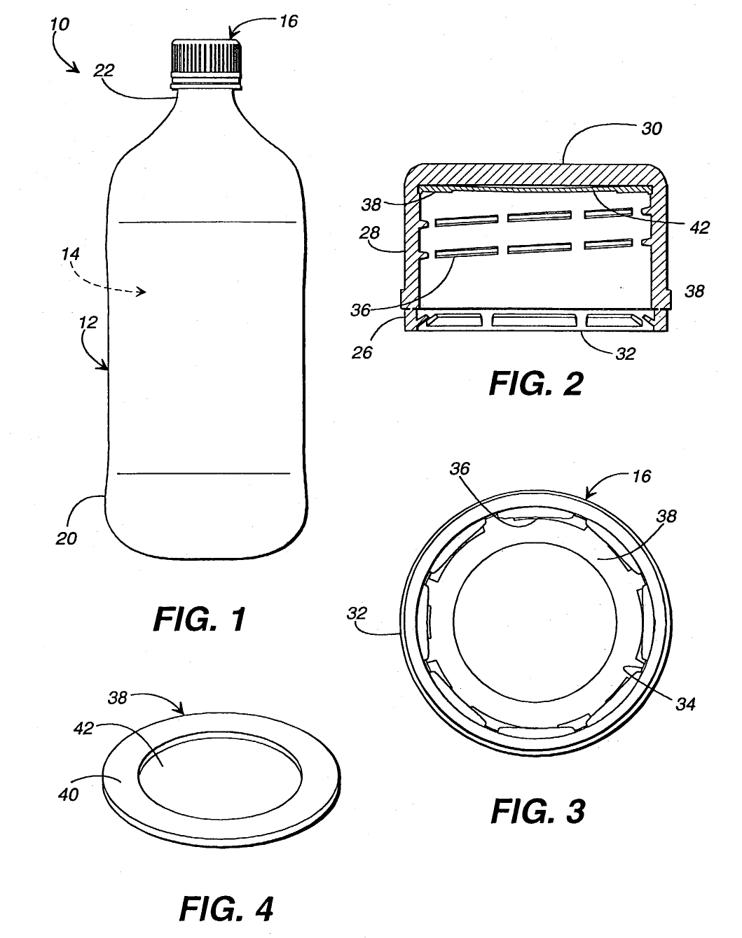

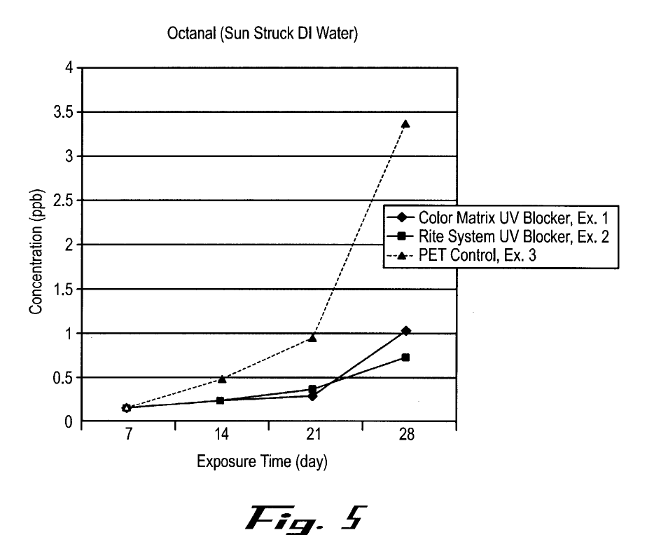

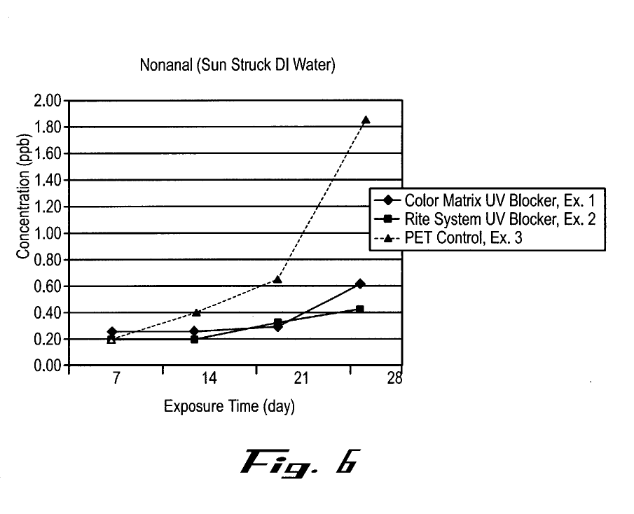

FIG. 1 illustrates a package 10 of potable water comprising a container 12 containing ozonated water 14 and sealed by a closure 16. The container 12 includes a shell 20 which is a typical plastic water bottle including a threaded neck 22 leading to a mouth or opening. The container 12 is made by conventional methods and is desirably formed of polyethylene terephthalate (PET). The container 12 can also be made of other thermoplastic materials including polypropylene, polyethylene, polystyrene, and the like, and materials such as metal or glass.

The container 12 desirably comprises an ultraviolet light (LN) absorber. The UV light absorber desirably blocks passage of UV light through the container and protects the contents of the container from exposure to UV light. According to one embodiment, the UV light absorber can be a material dispersed in the matrix of the container body. For example, according to a preferred embodiment, the UV light absorber is dispersed in the plastic matrix of a plastic container. Preferred UV light absorbers for dispersing in plastic container bodies include hydroxybenzophenones, cyanoacrylates, (phenylhydoxy)cinnmates, benzotriazoles, triazines, benzoxazinones, oxanilides, 2,6-naphthalene dicarboxylate, and naphthalene dicarboxylic acid. These UV light absorbers are all commercially available from multiple suppliers, and thus are referred to by a number of tradenames.

According to another embodiment, the UV blocker can be in the form of a coating on the container. Desirable coatings include acrylic coating and water based organic coating. Methods for applying such coatings such as dipping, spraying, vapor deposition are well known.

The potable liquid 14 in the container is desirably ozonated water, but can also be any one of a variety of beverages such as coffee, tea, fruit and vegetable juice, isotonic beverages and non-isotonic beverages. With bottled water, ozone is added to kill microorganisms in the water. This is accomplished by conventional means.

FIGS. 2 and 3 further illustrate the closure 16. As can be seen, the closure 16 includes a shell 26 comprising a cylindrical side wall 28 extending between a top cover 30 and an opening 32 for receiving the threaded neck 22 of the container 12. The interior 34 of the closure shell 26 includes threads 36 which mate with threads on the exterior of the container neck 22.

The closure 16 can be made of materials such as metal or glass, but is desirably made of a thermoplastic material. Suitable thermoplastic materials for the cap include polypropylene, polyethylene such as linear low density polyethylene (LLDPE), high density polyethylene (HDPE), PET, polystyrene, and the like. The closure 16 is made by conventional means understood by those skilled in the art.

The closure 16 also includes a thermoplastic liner 38 disposed in the interior 34 of the closure shell 26 against the top cover 30 of the closure. The liner creates a fluid-tight seal between the mouth of the container 12 and the closure 16 when the closure is threaded tightly onto the neck 22 of the container. The liner 38 includes a raised outer ring 40 which directly contacts the mouth of the container 12 and a recessed central portion 42 inside the outer ring.

The thermoplastic liner 38 is made and deposited inside the closure 16 by conventional means. For example, the liner 38 can be compression molded and then inserted into the closure shell 26 or the liner can be formed in situ by depositing heated thermoplastic liner material in the closure shell 26 and pressing the thermoplastic material against the top cover 30 of the closure.

Suitable thermoplastics to form the polymer matrix of the liner include ethylene vinyl acetate (EVA), polyvinyl chloride (PVC), PET, polyethylene, polypropylene, polyurethane, copolymers of vinyl chloride and vinyl acetate, ethylcellulose, cellulose acetate, cellulose acetate butyrate, terpolymers, alkylacrylates, copolymers and terpolymers of styrene, polyamides, polyesters, and other polyolefins.

The thermoplastic material of the liner 38 also includes conventional additives known to those skilled in the art and, in accordance to this invention, includes an organic slip agent. The slip agent is capable of dissolving in the potable ozonated liquid and undergoing photo-oxidation on exposure to ultraviolet light to form off-taste imparting compounds. Desirably, the slip agent is an ethylenically unsaturated slip agent. Erucamide is a preferred slip agent.

Other desirable ethylenically unsaturated slip agents for the liner 38 include erucamide, oleamide and mixtures thereof. Generally, suitable slip agents of the present invention include any ethylenically unsaturated organic compound that meets the requirements of a slip agent. A slip agent is a material that is incorporated into the polymer matrix of the liner and lubricates the outer surface of the liner so that the closure 16 can be easily removed from the neck 22 of the container 12, even when tightly threaded onto the neck of the container. Desirably, the slip agent is present in the liner in an amount from about 0.2% to about 2% by weight of the liner. For example, the liner 38 can comprise 99 parts EVA, 2 parts erucamide, and 0.1 parts of a blue colorant.

Although the closure 16 illustrated in FIGS. 1-3 includes a liner 38 as a sealing portion, sealable closures can be made without liners. In such a case, the polymer matrix of the closure shell includes a slip agent and is the sealing portion. The same saturated slip agents described above are suitable in a linerless closure and are desirably present in the polymer matrix of the closure in the same amounts as in the liner. Although not desirable, the container shell 12 could include the slip agent.

A portion of the organic slip agent in the closure dissolves in the potable liquid in the container over time, but with protection by the UV light absorber of the container from exposure to UV light, the organic slip agent undergoes conversion to off-taste compounds at a much slower rate. Accordingly, the packaged potable liquid has less of a plastic off-taste than it otherwise would without the presence of the UV light absorber.

The following examples 1, 2 and 4 illustrate embodiments of this invention and examples 3 and 5 illustrate bottle water packaging without a UV absorber for comparison.

### EXAMPLE 1

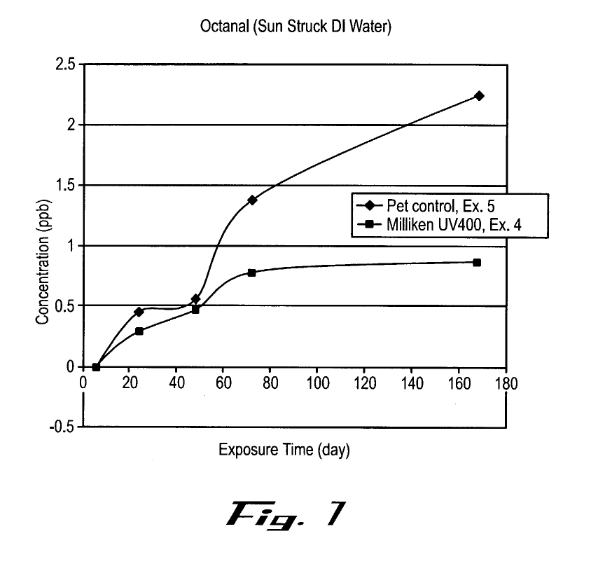

A PET bottle was formed comprising PET and 0.2 wt % by weight of a benzotriazole UV blocker (provided by ColorMatrix Corporation) that had less than 10% of light transmission up to 380 nm. The container was filled with distilled water and sealed with a polypropylene closure comprising a liner comprised of EVA and erucamide. The bottled water was placed outdoors and exposed to the sun for 28 days. At regular intervals, the levels of octanal and nonanal were measured. The results are shown in Table 1 and in the graphs illustrated in FIGS. 5 and 6.

TABLE 1

| Sample | Time (days) | Octanal (ppb) | Nonanal (ppb) |
|---|---|---|---|
| 1 | 7 | 0.13 | 0.24 |
| 2 | 14 | 0.23 | 0.26 |
| 3 | 21 | 0.29 | 0.29 |
| 4 | 28 | 1.04 | 0.62 |

### EXAMPLE 2

A PET bottle was formed comprising PET and <0.2wt % of a benzotriazole UV blocker provided by Rite Systems that had less than 10% of light transmission up to 380 nm. The container was filled with distilled water and sealed with polypropylene closure comprising a liner comprised of EVA and crucamide. The bottled water was placed outdoors and exposed to the sun for 28 days. At regular intervals, the levels of octanal and nonanal were measured. The results are shown in Table 2 and in the graphs illustrated in FIGS. 5 and 6.

TABLE 2

| Sample | Time (days) | Octanal (ppb) | Nonanal (ppb) |
|---|---|---|---|
| 1 | 7 | 0.15 | 0.20 |
| 2 | 14 | 0.22 | 0.20 |
| 3 | 21 | 0.35 | 0.32 |
| 4 | 28 | 0.74 | 0.42 |

### EXAMPLE 3 (COMPARATIVE)

A PET bottle was formed comprising PET. The container was filled with distilled water and sealed with a polypropylene closure comprising a liner comprised of EVA and erucamide. The bottled water was placed outdoors and exposed to the sun for 28 days. At regular intervals, the levels of octanal and nonanal were measured. The results are shown in Table 3 and in the graphs illustrated in FIGS. 5 and 6.

TABLE 3

| Sample | Time (days) | Octanal (ppb) | Nonanal (ppb) |
|---|---|---|---|
| 1 | 7 | 0.16 | 0.20 |
| 2 | 14 | 0.47 | 0.39 |
| 3 | 21 | 0.91 | 0.68 |
| 4 | 28 | 3.36 | 1.86 |

### EXAMPLE 4

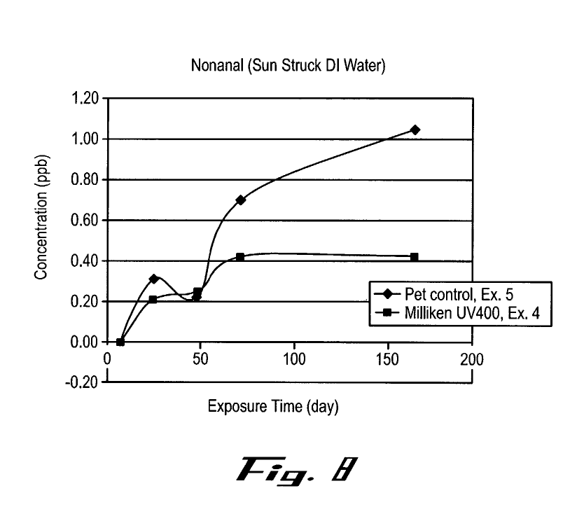

A PET bottle was formed comprising PET and 0.2wt % by weight of a hydroxycinnamate UV blocker provided by Milliken Chemical (tradenamed UV400), which has less than 10% of light transmission up to 390 nm. The container was filled with distilled water and sealed with a polypropylene closure comprising a liner comprised of EVA and Erucamide. The bottled water was placed inside the weather-o-meter and exposed to UV light at energy level 0.5 for a time of 168 hours. At regular intervals, the levels of octanal and nonanal were measured. The results are shown in Table 4 and in the graphs illustrated in FIGS. 7 and 8.

TABLE 4

| Sample | Time (hours) | Octanal (ppb) | Nonanal (ppb) |
|---|---|---|---|
| 1 | 24 | 0.28 | 0.21 |
| 2 | 48 | 0.47 | 0.25 |
| 3 | 72 | 0.77 | 0.42 |
| 4 | 168 | 0.87 | 0.42 |

### EXAMPLE 5 (COMPARATIVE)

A PET bottle was formed comprising PET. The container was filled with distilled water and sealed with a polypropylene closure comprising a liner having the comprised of EVA and erucamide. The bottled water was placed in side the weather-o-meter and exposed to UV light at energy level 0.5 for a time of 168 hours. At regular intervals, the levels of octanal and nonanal were measured. The results are shown in Table 5 and in the graphs illustrated in FIGS. 7 and 8.

TABLE 5

| Sample | Time (hours) | Octanal (ppb) | Nonanal (ppb) |
|---|---|---|---|
| 1 | 24 | 0.44 | 0.31 |
| 2 | 48 | 0.55 | 0.25 |
| 3 | 72 | 0.37 | 0.70 |
| 4 | 168 | 2.26 | 1.05 |

Based on the results illustrated in Tables 1-5 and FIGS. 5-8, it can be seen that the UV light absorber used in Examples 1,2 and 4 substantially slows and reduces the conversion of erucamide to octanal and nonanal. Although trans-2-decanal levels are very similar for all the examples, the nonanal and octanal levels are substantially lower for the UV absorber bottles than comparison PET bottles. As trans-2-decenal further reacts to form octanal and nonanal, the octanal and nonanal levels reflect the effectiveness of the UV absorbers.

It should be understood that the foregoing relates to preferred embodiments of this invention and that numerous changes may be made therein without departing from the scope of the invention as defined by the following claims.

We claim:

1. A packaged potable liquid comprising:
a container having an opening;
a potable ozonated liquid within the container; and
a removable closure having a sealing portion for contacting the container and sealing the opening,
wherein the sealing portion of the closure comprises a first plastic matrix and an organic slip agent dispersed in the first plastic matrix, the slip agent capable of dissolving in the potable ozonated liquid and undergoing photo-oxidation on exposure to ultraviolet light to form an off-taste imparting compound, and wherein the container comprises a container body and an ultraviolet light absorber for protecting the organic slip agent from exposure to ultraviolet light.

2. A packaged potable liquid as in claim 1 wherein the container body comprises a second plastic matrix and the ultraviolet light absorber is dispersed in the second plastic matrix.

3. A packaged potable liquid as in claim 1 wherein the container body comprises a second plastic matrix and the ultraviolet light absorber is coated on the container body.

4. A packaged potable liquid as in claim 1 wherein potable ozonated liquid is ozonated water.

5. A packaged potable liquid as in claim 1 wherein the ultraviolet light absorber is selected from the group consisting of hydroxybenzophenones, cyanoacrylates, (phenylhydoxy)cinnamates, benzotriazoles, triazines, benzoxazinones, oxanilides, naphthalene dicarboxylate and naphthalene dicarboxylic acid.

6. A packaged potable liquid as in claim 1 wherein the ultraviolet light absorber is benzotriazole.

7. A packaged potable liquid as in claim 1 wherein the organic slip agent is ethylenically unsaturated.

8. A packaged potable liquid as in claim 1 wherein the organic slip agent is an unsaturated fatty acid amide.

9. A packaged potable liquid as in claim 1 wherein the organic slip agent is an erucamide.

10. A packaged potable liquid as in claim 1 wherein the organic slip agent is an erucamide and the off-taste compound is nonanal.

11. A packaged potable liquid as in claim 1 wherein the organic slip agent is selected from the group consisting of erucamide and oleamide.

12. A packaged potable liquid as in claim 1 wherein the closure is a dispensing closure comprising a spout.

13. A packaged potable liquid as in claim 1 wherein the sealing portion of the closure is a liner.

14. A packaged potable liquid as in claim 1 wherein the second plastic matrix is polyethylene terephthalate.

15. A method for packaging potable liquid comprising:
filling a container with a potable ozonated liquid through an opening in the container; and
sealing the container opening with a removable closure having a sealing portion contacting the container,
wherein the sealing portion of the closure comprises a first plastic matrix and an organic slip agent dispersed in the first plastic matrix, the slip agent capable of dissolving in the potable ozonated liquid and undergoing photo-oxidation on exposure to ultraviolet light to form an off-taste imparting compound, and wherein the container comprises a container body and an ultraviolet light absorber for protecting the organic slip agent from exposure to ultraviolet light.

16. A method as in claim 15 wherein the container body comprises a second plastic matrix and the ultraviolet light absorber is dispersed in the second plastic matrix.

17. A method as in claim 15 wherein the container body comprises a second plastic matrix and the ultraviolet light absorber is coated on the container body.

18. A method as in claim 15 wherein potable ozonated liquid is ozonated water.

19. A method as in claim 15 wherein the ultraviolet light absorber is selected from the group consisting of hydroxybenzophenones, cyanoacrylates, (phenylhydoxy)cinnamates, benzotriazoles, triazines, benzoxazinones, oxanilides, naphthalene dicarboxylate and naphthalene dicarboxylic acid.

20. A method as in claim 15 wherein the ultraviolet light absorber is benzotriazole.

21. A method as in claim 15 wherein the organic slip agent is ethylenically unsaturated.

22. A method as in claim 15 wherein the organic slip agent is an unsaturated fatty acid amide.

23. A method as in claim 15 wherein the organic slip agent is an erucamide.

24. A method as in claim 15 wherein the organic slip agent is an erucamide and the off-taste compound is nonanal.

25. A method as in claim 15 wherein the organic slip agent is selected from the group consisting of erucamide and oleamide.

26. A method as in claim 15 wherein the closure is a dispensing closure comprising a spout.

27. A method as in claim 15 wherein the sealing portion of the closure is a liner.

28. A method as in claim 15 wherein the second plastic matrix is polyethylene terephthalate.
